(19) United States
(12) Patent Application Publication
(10) Pub. No.: US 2024/0379098 A1
(43) Pub. Date: Nov. 14, 2024

(54) Intelligent Command and Control Stack

(71) Applicant: Smart Response Technologies, Inc., Lebanon, OH (US)

(72) Inventors: Dalton PONT, Aldie, VA (US); Edward CRAIG, Woodbridge, VA (US)

(73) Assignee: Smart Response Technologies, Inc., Lebanon, OH (US)

(21) Appl. No.: 18/661,962

(22) Filed: May 13, 2024

Related U.S. Application Data
(60) Provisional application No. 63/465,981, filed on May 12, 2023.

(51) Int. Cl. G10L 15/183; G06V 10/774; G06V 20/50; G10L 15/06; G10L 15/22

(52) U.S. Cl. CPC G10L 15/183; G06V 10/774; G06V 20/50; G10L 15/063; G10L 15/22

(57) ABSTRACT

Implementations generate situation-specific command recommendations using machine learning. A response to a multi-faceted situation can be challenging to devise and coordinate. Implementations of a command and control stack can ingest situational data for an ongoing situation and generate command recommendations for a responder team. For example, an ensemble machine learning model that comprises multiple model components (e.g., generative natural language models, neural networks, etc.) can be trained to generate command recommendations using the ingested situational data. The command recommendations can be provided to member(s) of the responder team, such as displayed via a dashboard, provided via a digital agent, and the like.

### FIELD

The embodiments of the present disclosure generally relate to generating situation-specific command recommendations using machine learning.

### BACKGROUND

Rapid response teams are posed with complex problems sets. Many military, global relief, public safety, and/or situation response missions involve rapid responses to these situations. For example, some ongoing situations pose life critical risks that present dynamic, chaotic, and confusing environments where timeliness is impactful.

Due to the volume of information, number of decisions, and risk involved, members of a responder team, such as leaders or commanders, can be tasked with overwhelming responsibilities. Systems that can aid responder teams during an ongoing situation can provide substantial value and improve response outcomes.

### SUMMARY

Implementations resolve commands for responding to an ongoing situation using machine learning. Situational data from multiple data sources can be ingested, where the situational data comprises image-based situational data and natural language data that relates to an ongoing situation, and at least a portion of the situational data relates to response activities of a responder team for the ongoing situation. An ensemble machine learning model comprising at least a first model and a second model can generate recommended commands. For example, the recommended commands can be generated by: recognizing, via the first model using the ingested situational data, state information about the ongoing situation; and generating, via the second model, the recommended commands. The second model can comprise a generative natural language model configured to compare a) at least a portion of the situational data and the recognized state information; and b) plan data for the ongoing situation that comprises template commands, and the second model can generate the recommended commands based on the comparison. The recommended commands can be provided to a member of the responder team.

Features and advantages of the embodiments are set forth in the description which follows, or will be apparent from the description, or may be learned by practice of the disclosure.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a system for generating situation-specific command recommendations using machine learning according to example embodiment(s).

FIG. 2 illustrates a diagram of a computing system according to example embodiment(s).

FIG. 3A is a conceptual diagram that illustrates system components for generating situation-specific command recommendations using an ensemble machine learning model according to example embodiment(s).

FIG. 3B is a conceptual diagram that illustrates system components for maintaining an ensemble machine learning model configured to generate situation-specific command recommendations according to example embodiment(s).

FIG. 3C is a conceptual diagram that illustrates system components for providing situation-specific command recommendations to a responder team member according to example embodiment(s).

FIG. 4A is a conceptual diagram that illustrates a graph of template commands for plan data according to example embodiment(s).

FIG. 4B is a conceptual diagram that illustrates plan data comprising template commands according to example embodiment(s).

FIG. 5 illustrates a flow diagram for training a machine learning model to generate situation-specific command recommendations according to example embodiment(s).

FIG. 6 illustrates a flow diagram for generating situation-specific command recommendations using machine learning according to example embodiment(s).

### DETAILED DESCRIPTION

Implementations generate situation-specific command recommendations using machine learning. A response to a multi-faceted situation can be challenging to devise and coordinate. For example, a responder team (e.g., commander, first responders, etc.) may perform actions to manage the situation while it is ongoing, and to be effective those actions should be strategic, precise, and coordinated.

Implementations of a command and control stack can ingest situational data for the ongoing situation and generate command recommendations for the responder team. For example, an ensemble machine learning model that comprises multiple model components can be trained to generate command recommendations using the ingested situational data. The command recommendations can be provided to member(s) of the responder team, such as displayed via a dashboard, provided via a digital agent, and the like.

The ensemble machine learning model can serve as a cognitive system for the command and control stack. This cognitive system can learn to provide command recommendations for responder team members for rapid response operations (e.g., public safety responders, military, aviation, global humanitarian, and other life critical operations). Implementations of the command and control stack comprise a modular and layered cognitive system supported by a natural language processing (NLP) user interface(s). Some rapid response operations depend on a wide range of multi-modal and multi-media situational data (e.g., space, air, mobile ground/surface, and/or fixed sensors, etc.) for awareness. The voluminous amount of real-time data generated can overwhelm responder team members. Therefore, the responder team can benefit from a layered cognitive learning model that learns from historic instances and/or continually learns from an ongoing situational response. In addition, command recommendations can broadly refer to recommendations for tasks to be performed (e.g., by responder team members, coordinators, vehicles, drones, stakeholders, etc.), actions to be taken, data to be obtained, information to be shared, and the like. For example, the command recommendations generated by embodiments of the command and control stack can address any suitable aspect(s) for responding to an ongoing situation.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

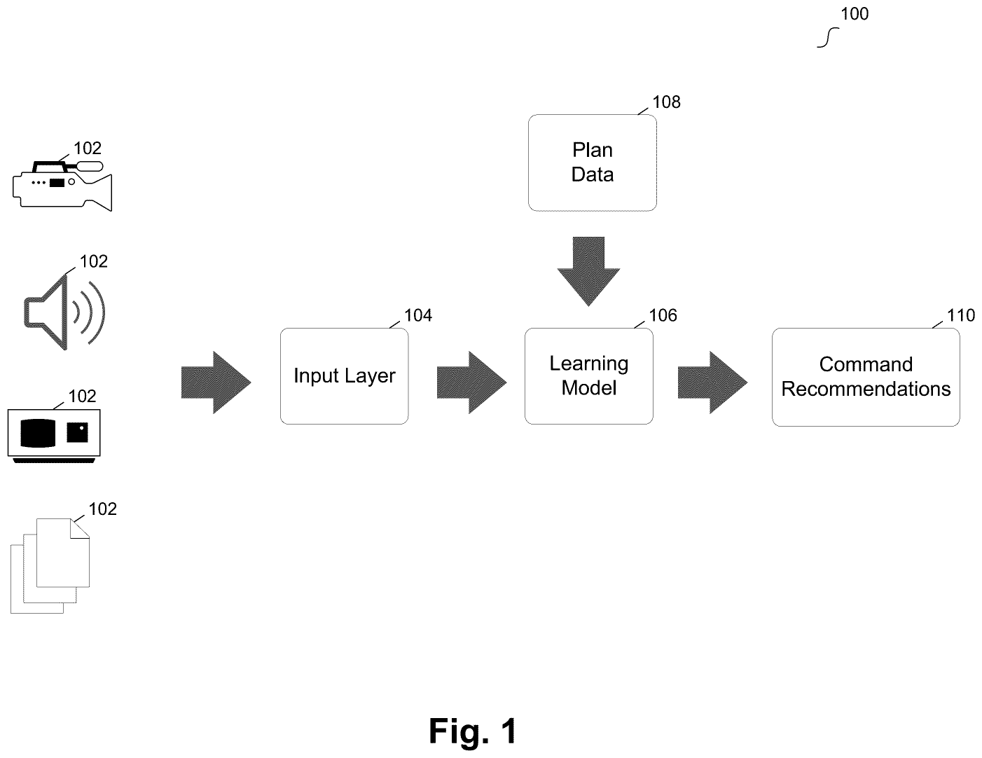

FIG. 1 illustrates a system for generating situation-specific command recommendations using machine learning according to example embodiment(s). Diagram 100 illustrates input source(s) 102, input layer 104, learning model 106, plan data 108, and command recommendations 110. Command recommendations 110 can comprise recommended commands for responding to an ongoing situation. For example, the ongoing situation can be a fire (e.g., forest/brush fire, fire in a residential area, fire in a commercial area, house fire, apartment fire, fire in a commercial building, fire in a school, etc.), violence against a group of people, structure(s), or any other suitable violence or attack (e.g., international or domestic terrorist attack, mass shooting, riots, etc.), weather related emergency (e.g., hurricane, flooding, etc.), global relief issue (e.g., humanitarian aid distribution, etc.), public safety issue, a military or police operation, any other suitable situation that impacts a group of people and/or a large area, or any other suitable ongoing situation.

Input source(s) 102 can be any source for situational data related to the ongoing situation, such as images or video (e.g., video of people, places, buildings, threats, and the like) via unmanned aerial vehicles, manned aircraft, body and/or dash cameras, fixed cameras, social media feeds, or any other suitable sources of images or video, audio (e.g., dialogue between responders or impacted individuals, audio from the scene(s) of the ongoing situation, etc.) via smartphones, landline calls, communication device(s) among responder team members, fixed microphone(s), or any other suitable source for audio, sensor data sources (e.g., fire or smoke detectors, gunshot or panic detectors, traffic sensors, flood sensors, temperature sensors, etc.), other suitable data sources (e.g., traffic conditions, weather conditions, tides/currents, sewage and/or plumbing information, flood zones, indoor and/or outdoor imagery or blueprints, building schematics, street maps, geographic information system (GIS) data, etc.), intelligence information sources (e.g., discovered, known, and/or suspected information about an ongoing threat), or any other suitable situational data sources.

In some implementations, input layer(s) 104 can comprise situational data ingested from multi-media sources, such as via an ingestion engine (e.g., cloud-based, on-premises, edge-based, etc.) that securely receives, tags, and stores media streams (e.g., video, voice, data). Input layer(s) 104 can comprise analytical model(s) and/or machine learning model(s) that are trained to process data from input source(s) 102 to detect key words, phrases, people, scenes, objects, activities, and/or gestures, to generate alerts for incoming data that is deemed a priority for the ongoing situation, and the like. In some implementations, input layer(s) 104 can comprise different layer(s) of analytical model(s) and/or machine learning model(s), each being trained for a designated use case. In some implementations, input layer(s) 104 process real-time situational data. For example, at least a portion of the situational data can comprise time-series data that is correlated/processed according to timing parameters (e.g., time stamped, grouped according to timestamps, etc.).

In some implementations, output from input layer(s) 104 for image and/or video input data can include object detection, gesture detection, scene detection, change recognition, motion tracking, thermal gradients with alerts and/or triggers, or any other suitable image or video processing output. Output from input layer(s) 104 for audio input data can include transcripts of dialogues, keyword alerts and/or triggers, sentiment detection, or any other suitable audio processing output. Output from input layer(s) 104 for sensor input data, map and/or location data, schematic data, inventory data, and the like can include locations for response resources (e.g., vehicles, human responders, etc.), asset tracking and/or management, service records, geo-boundaries, sensor activation, proximity infringement alerts and/or triggers, or any other suitable data processing output.

Data from input layer 104 (e.g., processed input data) and/or input source(s) 102 (e.g., raw data) can be input to learning model 106, such as machine learning model(s) trained to generate command recommendations 110. Data from input layer 104 and/or input source(s) 102 fed to learning model 106 can be considered situational data for the ongoing situation. In some implementations, learning model 106 is configured and/or trained to compare the situational data to plan data 108, such as a predefined response template comprising template commands and/or aggregated historical commands, to generate command recommendations 110.

In an example situation comprising a wildfire, a responder team is tasked with pursuing several goals and/or priorities to navigate the situation, such as protecting people and/or infrastructure, controlling the fire, deploying resources, and the like. Example command recommendations 110 related to a wildfire situation can include: recommendation(s) to build fire break(s) relative to certain assets (e.g., protecting infrastructure, people, etc.), recommendation(s) to abandon/evacuate areas in the fire's path, recommendation(s) to mobilize responders (e.g., firefights) from nearby areas, recommendation(s) to deploy aerial assets to evacuate people, recommendation(s) to deploy aerial assets to administer water or retardant, recommendation(s) to instruct/task a data source to obtain current data (e.g., instruct a drone to obtain updated image(s) or video of the fire), recommendation(s) to share information to fellow responder teams, stakeholders, media, and the like, or any other suitable commands related to responding to a wildfire.

In another example situation comprising one or more violent individuals, a responder team is tasked with safely navigating threats, such as by protecting bystanders or hostages, isolating the violent individual(s), deploying resources, and the like. Example command recommendations 110 related to a situation with violent individual(s) can include: recommendation(s) to evacuate buildings, rooms, geographic areas, and the like, recommendation(s) to build a perimeter around a dangerous area, recommendation(s) to deploy resources (e.g., police, swat team, negotiator, etc.) to locations, de-escalation recommendation(s) (e.g., find and contact the violent individual(s) family or known people, etc.), recommendation(s) to pursue research angles (e.g., obtain criminal history and/or known background for violent individual(s), etc.), recommendation(s) to deploy aerial assets to manage the situation, recommendation(s) to share information to a fellow responder team, stakeholders, media, and the like, or any other suitable commands related to responding to violent individual(s).

Implementations of the command and control stack can include technological components, such as an ensemble machine learning model, trained by proprietary knowhow to accelerate learning and to improve effectiveness by providing command recommendations that are further refined by commanders/users via feedback and personalization. For example, the command and control stack recommendations can reduce response times, clarify chaotic situations, and improve responses to urgent situations.

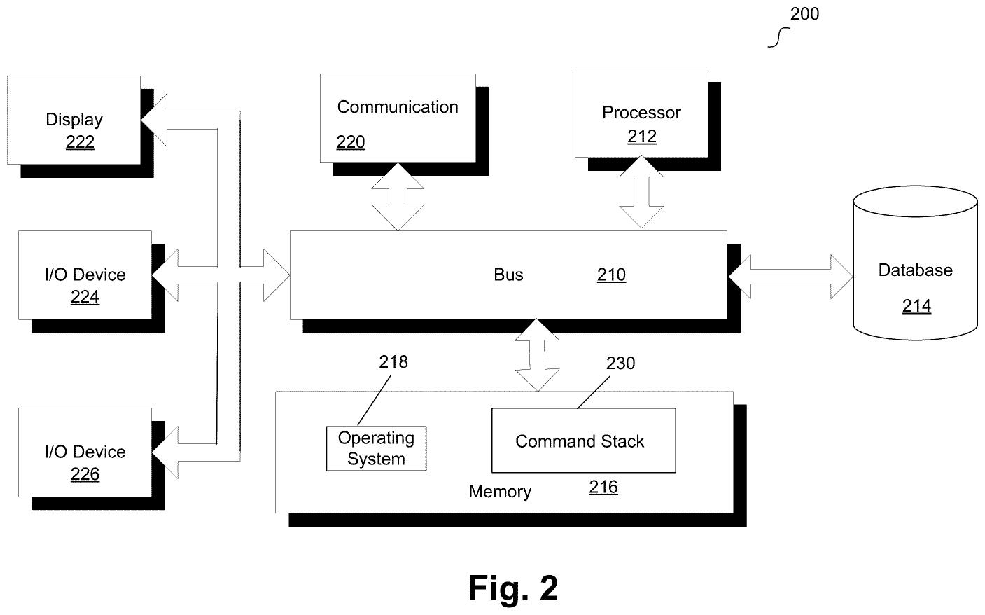

FIG. 2 is a diagram of a computing system 200 in accordance with embodiments. As shown in FIG. 2, system 200 may include a bus 210, as well as other elements, configured to communicate information among processor 212, data 214, memory 216, and/or other components of system 200. Processor 212 may include one or more general or specific purpose processors configured to execute commands, perform computation, and/or control functions of system 200. Processor 212 may include a single integrated circuit, such as a micro-processing device, or may include multiple integrated circuit devices and/or circuit boards working in combination. Processor 212 may execute software, such as operating system 218, visual command stack 230, and/or other applications stored at memory 216.

Communication component 220 may enable connectivity between the components of system 200 and other devices, such as by processing (e.g., encoding) data to be sent from one or more components of system 200 to another device over a network (not shown) and processing (e.g., decoding) data received from another system over the network for one or more components of system 200. For example, communication component 220 may include a network interface card that is configured to provide wireless network communications. Any suitable wireless communication protocols or techniques may be implemented by communication component 220, such as Wi-Fi, Bluetooth®, Zigbee, radio, infrared, and/or cellular communication technologies and protocols. In some embodiments, communication component 220 may provide wired network connections, techniques, and protocols, such as an Ethernet.

System 200 includes memory 216, which can store information and instructions for processor 212. Embodiments of memory 216 contain components for retrieving, reading, writing, modifying, and storing data. Memory 216 may store software that performs functions when executed by processor 212. For example, operating system 218 (and processor 212) can provide operating system functionality for system 200. Command stack 230 (and processor 212) can generate command recommendations for responder teams. Embodiments of command stack 230 may be implemented as an in-memory configuration. Software modules of memory 216 can include components of operating system 218, command stack 230, as well as other applications modules (not depicted).

Memory 216 includes non-transitory computer-readable media accessible by the components of system 200. For example, memory 216 may include any combination of random access memory (“RAM”), dynamic RAM (“DRAM”), static RAM (“SRAM”), read only memory (“ROM”), flash memory, cache memory, and/or any other types of non-transitory computer-readable medium. A database 214 is communicatively connected to other components of system 200 (such as via bus 212) to provide storage for the components of system 200. Embodiments of database 214 can store data in an integrated collection of logically-related records or files.

Database 214 can be a data warehouse, a distributed database, a cloud database, a secure database, an analytical database, a production database, a non-production database, an end-user database, a remote database, an in-memory database, a real-time database, a relational database, an object-oriented database, a hierarchical database, a multi-dimensional database, a Hadoop Distributed File System (“HFDS”), a NoSQL database, or any other database known in the art. Components of system 200 are further coupled (e.g., via bus 210) to: display 222 such that processor 212 can display information, data, and any other suitable display to a user, I/O device 224, such as a keyboard, and I/O device 226 such as a computer mouse or any other suitable I/O device. In some embodiments, system 200 can be an element of a system architecture, distributed system, or other suitable system. For example, system 200 can include one or more additional functional modules, open source software modules and/or libraries, or any other suitable modules. Data can be stored in any other suitable fashion, such as via flat files or any other suitable data structure or data store.

Embodiments of system 200 can remotely provide the relevant functionality for a separate device. In some embodiments, one or more components of system 200 may not be implemented. For example, system 200 may be a tablet, smartphone, or other wireless device that includes a display, one or more processors, and memory, but that does not include one or more other components of system 200 shown in FIG. 2. In some embodiments, implementations of system 200 can include additional components not shown in FIG. 2. While FIG. 2 depicts system 200 as a single system, the functionality of system 200 may be implemented at different locations, as a distributed system, a cloud infrastructure, an edge infrastructure, any combination thereof, or in any other suitable manner. In some embodiments, memory 216, processor 212, and/or database 214 are be distributed (across multiple devices or computers that represent system 200). In one embodiment, system 200 may be part of a computing device (e.g., smartphone, tablet, computer, and the like).

Embodiments of the command and control stack can learn from historical situational data to recommend actions that have similarity based on similar circumstances. The command and control stack can, for example: a) process voluminous amounts of sensor data in real time; b) manage complex incident responses in a manner similar to prior successful incidents; and c) provide command recommendations that optimize response efficiency and safety. The embodiments can include a cloud hosted architecture on a typical hub/spoke network topology, an edge architecture running on a mesh network topology, or any other suitable architecture.

The command and control stack integrates technological components into a cognitive system that can be trained using a mission knowledgebase, for example a knowledgebase comprising situational data (e.g., multimedia data, such as voice, video, text, sensor data, etc.) processed to generate training instances and/or other suitable training data for a machine learning model. Additionally, embodiments include a fusion of geolocated and time tagged outputs from multiple artificial intelligence layers, such as outputs compiled into periodic Incident Bursts (IBs) that provide commanders and responders improved situation awareness to better understand and act on recommended commands.

Implementations of the command and control stack support multiple concurrent operations and integrate responder teams collaborating from multiple organizations on an ongoing situation. These embodiments can also provide overall situation monitoring and/or observation for individual(s) who are not directly involved in the command/control and/or are not executing action tasks for a response to an ongoing situation. The input layer for some embodiments the command and control stack includes artificial intelligence processed sensor media, and the command and control stack can assist responder team members by recommending commands (e.g., response actions) and/or information distribution to ensure the responder teams' direction and intent are properly coordinated, communicated, understood, implemented, and tracked to completion. Embodiments of the command and control stack can, such as via a visible dashboard, also aid in coordinating and updating stakeholders.

An embodiment of the command and control stack is implemented via a web-based service hosted in a cloud system accessible by users (e.g., responders and/or viewers), such as via any web browser, mobile app, or other suitable software. In other embodiments, software components for the command and control stack are implemented at edge devices which are linked via a mesh network to enhance performance for designated use cases. Any combination of cloud device(s), edge device(s), on-premises device(s), home device(s), mobile device(s), and the like can implement the command and control stack functionality.

A “machine learning model,” as used herein, refers to a construct that is configured (e.g., trained using training data) to make predictions, provide probabilities, augment data, and/or generate data. For example, training data for supervised learning can include items with various parameters and an assigned classification. A new data item can have parameters that a model can use to assign a classification to the new data item. Machine learning models can be configured for various situations, data types, sources, and output formats. Example machine learning models include neural networks, deep neural networks, convolutional neural networks, deep convolutional neural networks, transformer networks, encoders and decoders, generative adversarial networks (GANS), large language models, clustering models, reinforcement learning models, probability distributions, decision trees, decision tree forests, and other suitable machine learning components.

Training data can be any set of data capable of training machine learning model(s), such as a set of features with corresponding labels for supervised learning. Training data can be used to train machine learning model(s) to generate trained machine learning model(s). For example, any suitable training technique (e.g., supervised training via gradient descent, unsupervised training, etc.) can be used to update a configuration of machine learning model(s) (e.g., train the weights of a machine learning model) using training data.

The architecture of implemented machine learning model(s) can include any suitable machine learning model components (e.g., sub-models, layers, processing blocks, processing branches, etc.). For example, a neural network can be implemented along with a given cost function (e.g., for training/gradient calculation). The neural network can include any number of hidden layers (e.g., 0, 1, 2, 3, or many more), and can include feed forward neural networks, recurrent neural networks, convolution neural networks, transformer networks, encoder-decoder architectures, large language model(s), and any other suitable type. In some implementations, the neural network can be configured for deep learning, for example based on the number of hidden layers implemented. In some examples, a Bayesian network can be similarly implemented, or other types of supervised learning models.

In some implementations, a k-nearest neighbor (“KNN”) algorithm can be implemented. For example, a KNN algorithm can determine a distance between input features and historical training data instances (e.g., training data instances of transactions with labels). One or more “nearest neighbors” relative to this distance can be determined (the number of neighbors can be based on a value selected for K). In some implementations, the determined nearest neighbors can have features similar to the input features. The KNN model can output a prediction based on the distances from these “nearest neighbor” instances.

In some implementations, machine learning model(s) can be an ensemble learning model. Multiple models can be stacked, for example with the output of a first model feeding into the input of a second model. Some implementations can include a number of layers of prediction models. In some implementations, features utilized by machine learning model(s) can also be determined, for example via any suitable feature engineering techniques.

In some implementations, the design of machine learning model(s) can be tuned during training, retraining, and/or updated training. For example, tuning can include adjusting a number of hidden layers in a neural network, adjusting parameters such as learning rate, temperate, etc., and the like. This tuning can also include adjusting/selecting features used by the machine learning model(s). Various tuning configurations (e.g., different versions of the machine learning model and features) can be implemented while training in order to arrive at a configuration for machine learning model(s) that, when trained, achieves desired performance (e.g., performs predictions at a desired level of accuracy, run according to desired resource utilization/time metrics, and the like). Retraining and updating the training can include training with updated training data. For example, the training data can be updated to incorporate observed data, or data that has otherwise been labeled (e.g., for use with supervised learning). In some implementations, machine learning model(s) can include an unsupervised learning component. For example, one or more clustering algorithms, such as hierarchical clustering, k-means clustering, and the like, or unsupervised neural networks, such as an unsupervised autoencoder, can be implemented.

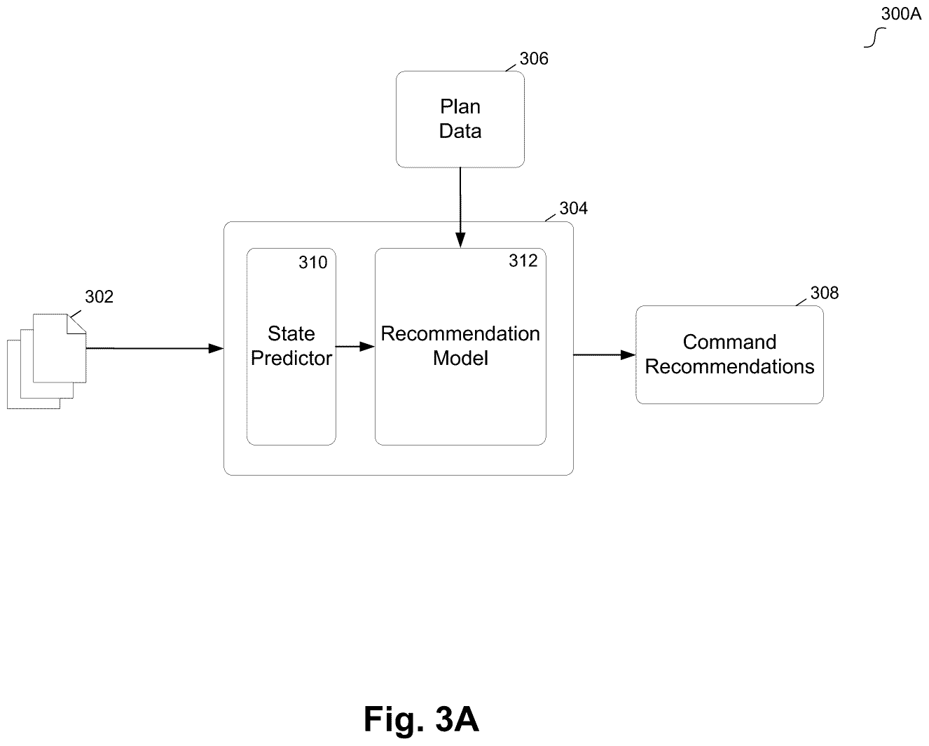

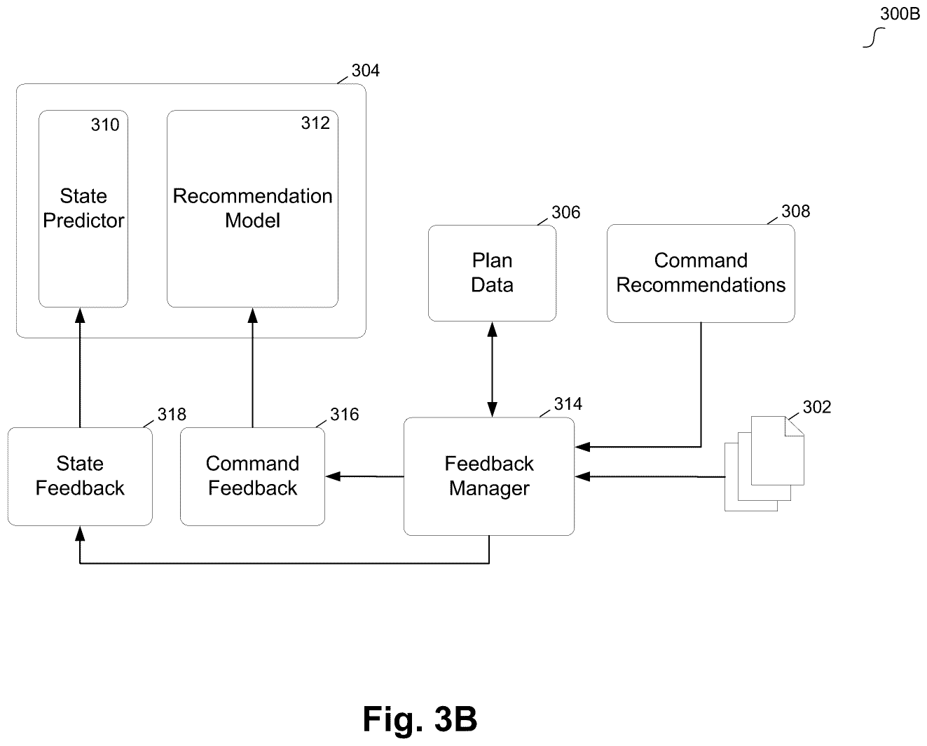

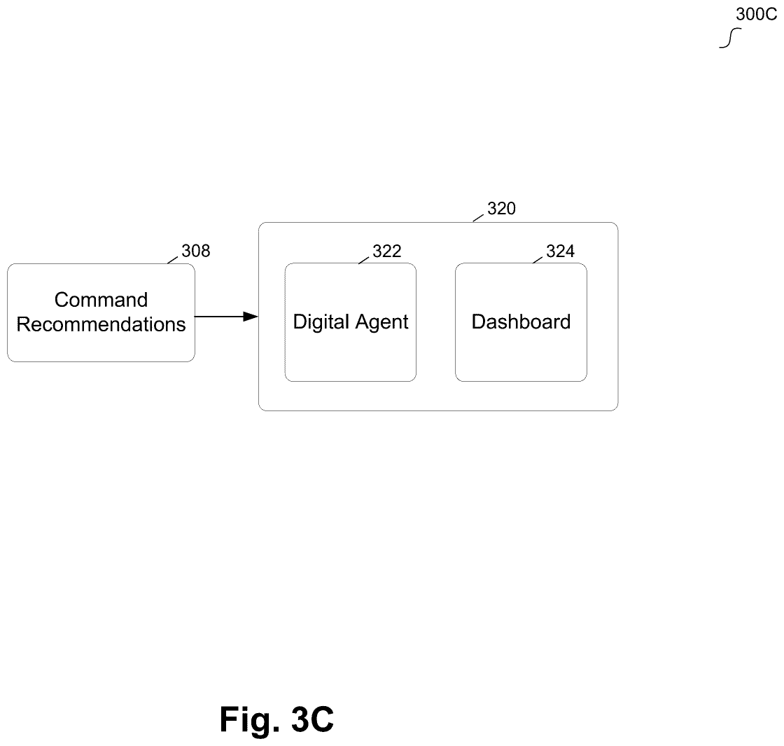

FIG. 3A is a conceptual diagram that illustrates system components for generating situation-specific command recommendations using an ensemble machine learning model according to example embodiment(s). Diagram 300A illustrates situational data 302, ensemble learning model 304, plan data 306, command recommendations 308, state predictor 310, and recommendation model 312. Situational data 302 can comprise data related to an ongoing situation, such as a fire (e.g., forest/brush fire, fire in a residential area, fire in a commercial area, house fire, apartment fire, fire in a commercial building, fire in a school, etc.), violence against a group of people, structure(s), or any other suitable violence or attack (e.g., international or domestic terrorist attack, mass shooting, riots, etc.), weather related emergency (e.g., hurricane, flooding, etc.), global relief issue (e.g., humanitarian aid distribution, etc.), public safety issue, a military operation, any other suitable situation that impacts a group of people and/or a large area, or any other suitable ongoing situation.

In some implementations, situational data 302 comprises data from input source(s) 102 and/or data from input layer 104 of FIG. 1. For example, situational data 302 can be images, video, output from processed image/video (e.g., recognized objects, gesture detection, natural language descriptions, change detection alerts, etc.), audio, output from processed audio (e.g., transcripts, keyword or phrase detection, summaries, etc.), environmental data (e.g., weather, tides/current data, terrain), sensor data (e.g., sensed temperature or environmental factor, detected gunshot, detected glass shattering, detected water/flood, detected proximity, detected opening/closing of a door or windows, a security alarm, etc.), other suitable data (e.g., map data, terrain information, architectural/structural data, street/traffic information, geographic information system (GIS) data, etc.), or any other suitable situational data. The below table includes examples of different data sources, data processing, and output from the data processing, where situational data 302 can include raw data from the source and/or output from the data processing.

| | Data Processing | Data Processing |
|---|---|---|
| Data Source | functionality | output |
| Voice Data | Multi-media Communication | Alerts |
| Radio | Voice to Text | Key Words |
| Phone | Play, Pause, Rewind | Phrases |
| | Audio Separation | |
| Image/Video Data | Recognition | Alerts |
| Aerial | Tag & Store | People & Things |
| Dash | Play, Pause, Rewind | Type, Class, Features |
| Body | Detection | Scenes Activities |
| Fixed | Recognition | Setting, Terrain, |
| Phone | Text Strings | Gestures, Features |
| | | Signs/Key Words |
| Other Data | Comprehension | Key Words/Phrases |
| Weather | Text Extract | MindHive: Fused |
| Tides/Current | Meaning Definition | with Voice AI & |
| Terrain | Word Assoc/Trends | Video AI into |
| Crime database | | Incident Bursts |
| MSDS | | (ICs) |

Situational data 302 can be fed to ensemble model 304, comprising state predictor 310 and recommendation model 312. State predictor 310 can predict a state of the ongoing situation using components of situational data 302. In an example where the ongoing situation comprises a wildfire, state predictor 310 can predict one or more of: a state of the fire (e.g., intensity, size, movement vector, coverage area, etc.), the state of deployed resources (e.g., fire fighters, vehicles, such as aerial vehicles, fire trucks, etc.), the state of infrastructure or people potentially impacted by the fire (e.g., infrastructure or people at risk), whether geographic areas are populated and/or evacuated, and other suitable state information. In another example, where the ongoing situation comprises violent individual(s), state predictor 310 can predict one or more of: a risk area associated with the violent individual(s) (e.g., occupied building, park or outdoor space, etc.), a health state of nearby bystanders (e.g., injuries), a risk to bystanders (e.g., individual(s) that are pinned down or stuck, individual(s) that have been taken as hostage(s), etc.), whether buildings or areas are populated or evacuated, a state of deployed resources (e.g., police officers, swat, vehicles, such as aerial vehicles, hostage negotiators, etc.), and other suitable state information.

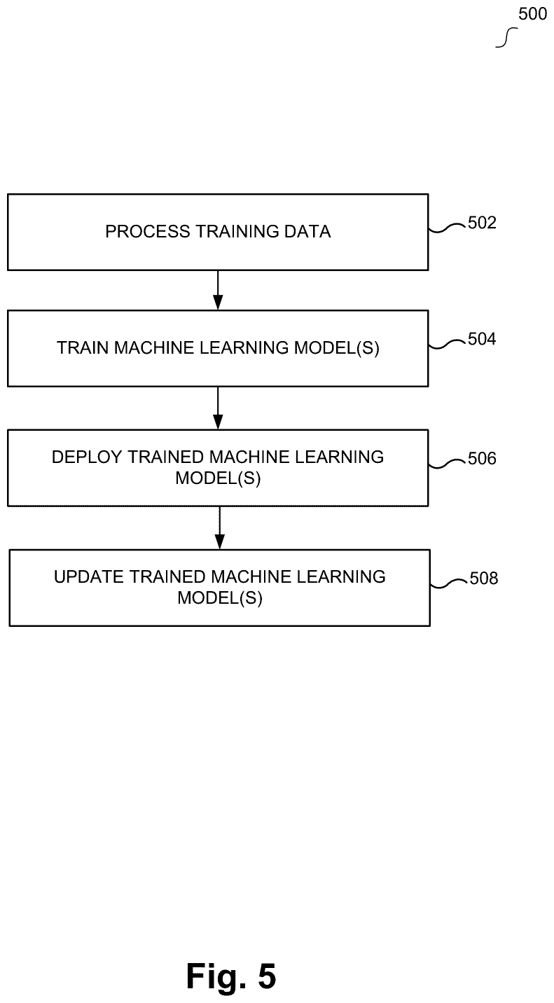

In some implementations, state predictor 310 can be one or more machine learning models, such as a large language model (LLM), transformer model (e.g., Bidirectional Encoder Representation from Transformers (BERT), generative encoder/decoder model, neural network, any other suitable natural language processing model, any combination thereof, or any other suitable model(s) trained to predict state information from situational data 302. For example, a pretrained LLM, transformer, or other suitable natural language processing model can be fine-tuned using historical situational data from previously experienced situations (e.g., transcripts of radio/phone conversations, commands, images, video, audio, processing images/video/audio, etc.,) that is compiled to comprise training data. Descriptions with respect to FIG. 5 further describes the training of state predictor 310 to predict state information for an ongoing situation.

In some implementations, state predictor 310 can be configured to predict one or more predefined states based on the type of ongoing situation. For example, different types of ongoing situations (e.g., wildfire, violent individual(s), riot, multiple fires, etc.) can comprise a different set of predefined prompts for state predictor 310.

The predefined prompts can configure state predictor 310 to output state information relevant to the current ongoing situation. For example, an ongoing wildfire can correspond to a set of prompts that configure state predictor 310 to predict, from situational data 302, state information related to a response to a wildfire, as described herein. In another example, a situation related to violent individual(s) can correspond to a set of prompts that configure state predictor 310 to predict, from situational data 302, state information related to a response to violent individual(s), as described herein. In another example, an ongoing situation may relate to multiple situation types, such as a public disturbance that includes violent individual(s) and one or more fires. In this example, the mixed ongoing situation can correspond to a set of prompts that configure state predictor 310 to predict, from situational data 302, state information related to a response to violent individual(s) and a response to fire(s).

In some implementations, a prompt selector can learn to select among the predefined prompts to configure the state information predicted by state predictor 310. For example, the prompt selector comprises a natural language processing model that is trained to identify one or more situation types for the ongoing situation, such as using situational data 302, state information predicted by state predictor 310 (e.g., past state information predicted for ongoing situation), and/or commands issued by recommendation model 312 (e.g., past command recommendations generated for ongoing situation). The prompt selector can then select predefined prompts based on the identified situation types. The predefined prompts can be organized according to any other suitable organization scheme, and the prompt selector can be trained to select predefined prompts that correspond to the ongoing situation according to the organization scheme.

In some implementations, the prompt selector can be trained via historical state information, historical situational data, and/or historical issued commands generated during responses to historical situations. The training of the prompt selector can improve the manner in which the selector recognizes aspects of ongoing situations and its selection of predefined prompts that are relevant to ongoing situations.

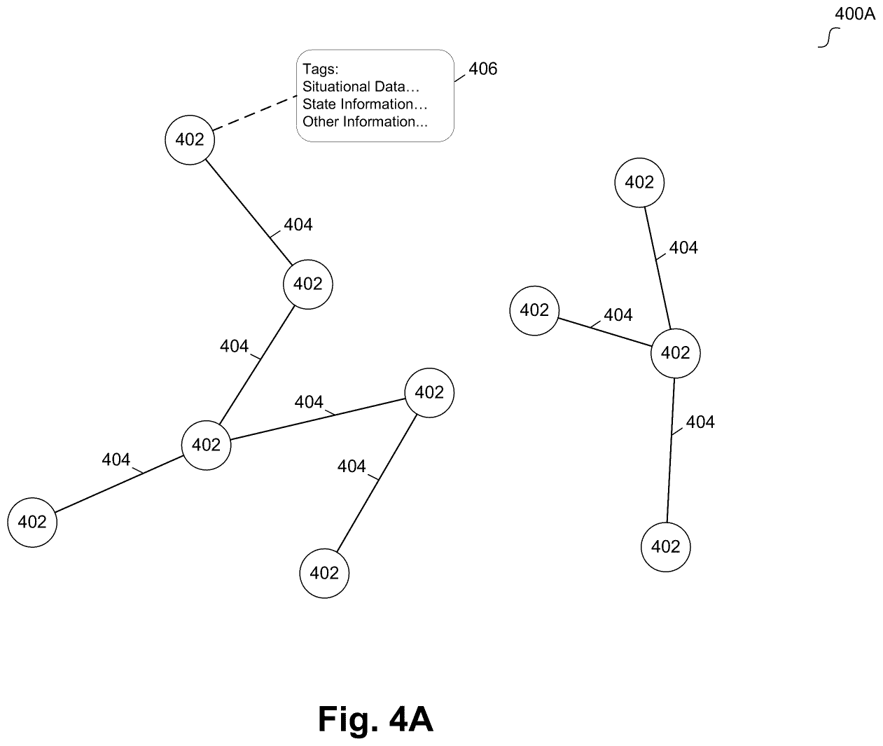

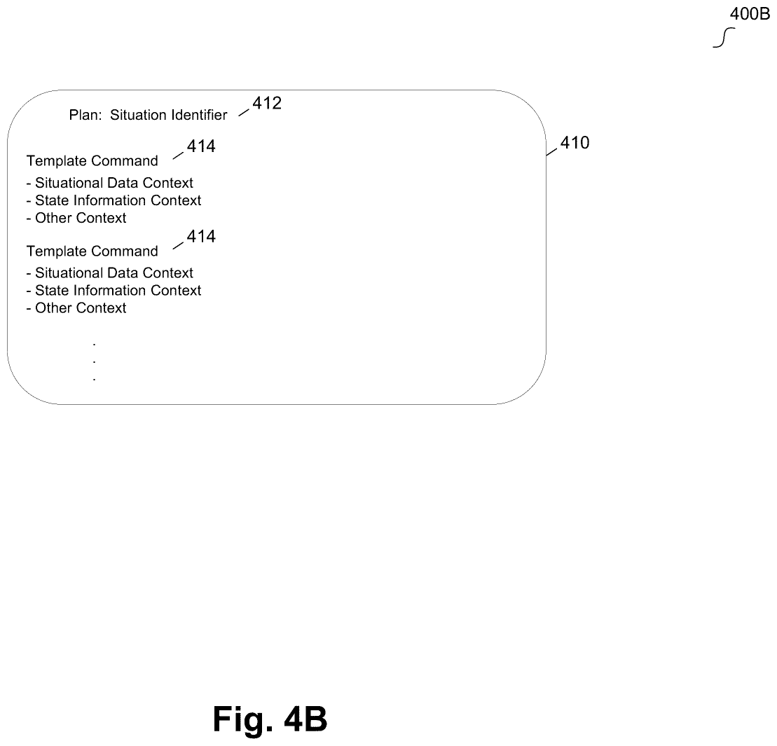

The state information predicted by state predictor 310 can be fed to recommendation model 312. In some implementations, recommendation model 312 can be fed the predicted state information and one or more components of situational data 302. Recommendation model 312 can comprise a generative machine learning model (e.g., generative LLM, generative encoder/decoder, generative adversarial network, etc.) trained to generate command recommendations 308 using this fed input and plan data 306. Plan data 306 can comprise a template plan for responding to an ongoing situation that includes template commands and/or historical commands (e.g., aggregated via feedback manager 314 of FIG. 3B). For example, plan data 306 can comprise template commands and tag(s) or context for these template commands (e.g., state information tags, situational data tags and/or data value ranges, etc.) and/or historical commands and context for the historical commands (e.g., historical state information and/or situational data that corresponds to the historical commands). Descriptions with respect to FIGS. 4A and 4B further describes an example structure of plan data 306.

Recommendation model 312 can be trained to select one or more template and/or historical commands of plan data 306, such as based on which of these command(s) are relevant to the state information and situational data fed to the recommendation model, and generate command recommendations 308 based on the selections. For example, a selected template and/or historical command may relate to evacuating an office building based on the state of a fire, and a generated command recommendation 308 may be to evacuate a residential area (rather than an office building). Recommendation model 312 may reformulate the command and insert the relevant entity (e.g., danger area) to be evacuated, for example based on understanding the state information and/or situational data fed to the model for the ongoing situation.

In another example, a selected template and/or historical command may relate to deploying a police unit and swat team to a location at risk, while the generated command recommendation 308 may be to deploy two police units, a swat team, and a fire truck to the location at risk. Recommendation model 312 may reformulate the command, based on understanding the state information and/or situational data fed to the model for the ongoing situation, to recommend a) deployment of available resources (an additional police unit and an additional fire truck are available in this example), and b) deployment of resources that respond to a specific risk of the ongoing situation (e.g., the fire truck is recommended based on the ongoing situation being a riot where fire(s) have been started). Any other suitable template commands and/or historical commands can be selected and reformulated by recommendation model 312 based on the state information and/or situational data for the ongoing situation. In some implementations, recommendation model 312 can combine multiple of template/historical commands, and in some examples reformulate the combined commands.

In some implementations, recommendation model 312 can be configured with instructions (e.g., prompts, settings, any other suitable instructions for a generative machine learning model) to generate commands similar to the template commands and/or historical commands from plan data 306 for the ongoing situation represented by the state information and situational data fed to the model. For example, recommendation model 312 can be configured with a setting that defines how much deviation (e.g., reformulation) from the original template commands and/or historical commands is permitted, such as a temperature parameter for a trained LLM. Descriptions with respect to FIG. 5 further describes the training of recommendation model 312 to generate command recommendations 308.

FIG. 3B is a conceptual diagram that illustrates system components for maintaining an ensemble machine learning model configured to generate situation-specific command recommendations according to example embodiment(s). Diagram 300B illustrates situational data 302, ensemble learning model 304, plan data 306, command recommendations 308, state predictor 310, recommendation model 312, feedback manager 314, command feedback 316, and state feedback 318. Feedback manager 314 can comprise analytical model(s) that compile feedback (e.g., updated training data) for recommendation model 312, such as command feedback 316, and state predictor 310, such as state feedback 318.

In embodiments, a situation is ongoing (e.g., occurring over a period of time) and thus situational data 302 can comprise time-based data, such as time-series data, data comprising time stamps, etc. In examples, the state information predicted by state predictor 310 at a first point in time can be validated or invalidated by situational data 302 of a second point in time. In another example, command recommendations 308 generated by recommendation model 312 at a third point in time can be validated or invalidated (e.g., adopted by the responder team, rejected by the responder team) by situational data 302 of a fourth point in time.

In some implementations, feedback manager 314 can comprise a natural language model configured to assess whether a predicted state actually occurs based on transcripts of discussions (e.g., among responder team members) that occur after the state is predicted. For example, feedback manager 314 can comprise a machine learning model that outputs a confidence score related to whether a state predicted by state predictor 310 for the ongoing situation actually occurs. When the confidence score is below a threshold (e.g., 50%, 60%, 80%, 90%, etc.), feedback manager can compile a training instance for state predictor 310. The training instance can include: the predicted state, at least a portion of the elements of situational data used by state predictor 310 to predict the state, and a label that indicates the predicted state was incorrect. The training instance can be used to update the training of state predictor 310. In some implementations, a group of training instances can be aggregated, and the instances can be used in combination to update the training of state predictor 310.

In another example, feedback manager 314 can comprise a natural language model configured to assess whether command recommendations 308 are implemented by the responder team based on transcripts of discussions (e.g., among responder team members) that occur after the commands are recommended or via any other situational data 302 relevant to command recommendations 308. For example, feedback manager 314 can comprise a machine learning model that outputs a confidence score related to whether one or more of the generated command recommendations were implemented by the responder team. When the confidence score is below a threshold (e.g., 50%, 60%, 80%, 90%, etc.), feedback manager can compile a training instance for recommendation model 312. In another example, a member of the responder team can explicitly indicate that one or more of command recommendations 308 were not implemented, such as through a user interface, digital agent, or any other suitable software.

The compiled training instance can include: the command recommendation, at least a portion of the input fed to the model (e.g., elements of situational data, state information, etc.) used to generate the command recommendation, and a label that indicates the command recommendation was incorrect. The training instance can be used to update the training of recommendation model 312. In some implementations, a group of training instances can be aggregated, and the instances can be used in combination to update the training of recommendation model 312.

In some implementations, feedback manager 314 can assess whether a series of command recommendations 308 are implemented/issued in the sequence or order recommended, such as based on transcripts of discussions (e.g., among responder team members) that occur after the commands are recommended or via any other situational data 302 relevant to the recommended series of commands. A compiled training instance in this example can include: the ordered sequence of command recommendations, at least a portion of the input fed to the model (e.g., elements of situational data, state information, etc.) used to generate the command recommendations, and a label that indicates the observed order for the series of command recommendations. The training instance can be used to update the training of recommendation model 312.

In some implementations, feedback manager 314 of FIG. 3B processes situational data 302 to generate a compilation of historical commands and context for those historical commands. For example, feedback manager 314 can comprise a natural language processing model trained to identify commands of importance from situational data 302. In some implementations, a command of importance can be identified based on a popularity (e.g., how frequent the command is issued), natural language reactions in transcripts (e.g., “thanks, you really saved me/them”), or in any other suitable manner. A historical command identified by feedback manager 314 can be associated with context for the historical command, such as situational data proximate to the timing when the historical command is issued. Feedback manager 314 can compile instances of this combination of the identified historical command(s) and context for the historical command(s) and, in some embodiments, add them to plan data 306. In some examples, historical command(s) are approved (e.g., by a person) before being added to plan data 306. Because plan data 306 represents a source for recommendation model 312 with respect to generating command recommendations 306, updates to plan data 306 based on historical commands identified as important can improve the functionality and effectiveness of recommendation model 312 and command recommendations 308.

FIG. 3C is a conceptual diagram that illustrates system components for providing situation-specific command recommendations to a responder team member according to example embodiment(s). Diagram 3000 illustrates situational command recommendations 308, output module 320, digital agent 322, and dashboard 324. Command recommendations 308 can be provided to responder team members, such as a commander, field/ground operative, pilot, etc., via output module 320. In some implementations, a digital agent (e.g., chat bot) can be configured to deliver command recommendation(s) 308 to the responder team member. For example, digital agent 322 can be an assistant for the responder team that can provide answers to queries using the situational data aggregated for the ongoing situation, such as “what is the weather like?”, “Did we issue a command to evacuate that building”, and the like. This digital agent can similarly provide command recommendations 308, such as via text or output as spoken words. Any suitable chatbot software and/or natural language processing model(s) can be used to implemented digital agent 322.

In another example, command recommendations 308 can be displayed to a responder team member via dashboard 324. For example, dashboard 324 can display elements of situational data for the ongoing situation to the responder team member. This dashboard can similarly display command recommendations 308 so that the team member can understand the recommendations and decide whether to issue the recommended commands. Dashboard 324 can be displayed via an application (e.g., native application, web application, progressive web application, etc.), browser, website, or any other suitable software. Dashboard 324 can be displayed by a desktop, laptop, tablet, smartphone, artificial reality device, heads-up display, any suitable mobile device, or any other suitable computing device.

In some implementations, multiple instances of the command and control stack can execute concurrently, for example to assist different responder teams, ingest different volumes/types of situational data, address different aspects of an ongoing situation, or for any other suitable purposes. The different command and control stacks can share information among one another, such as situational data, predicted state information, command recommendations, compiled training instances, any other suitable feedback, or any other suitable information. In an example, the predicted state information among all concurrently executing command and control stack instances can be shared to support effective command recommendations by the recommendation models of the different instances. In this example, the different command and control stack instances may process different types/volumes of situational data, and thus the state information predicted by the different instances can vary. Sharing this state information can improve knowledge sharing while reducing redundant processing of situational data.

FIG. 4A is a conceptual diagram that illustrates a graph of template commands for plan data according to example embodiment(s). Template plan 400A illustrates template commands 402, command links 404, and context information 406. Template plan 400A can include template commands 402, which can be connected via command links 404 to comprise a graph of template commands. The links among template commands 402 can represent causal, temporal, or any other suitable relationships. For example, a command to evacuate a dangerous area can be related to follow-up commands, such as deploying resources (e.g., police, vehicles, etc.) to perform the evacuation, establishing a perimeter around the evacuated area, etc. Accordingly, a subset of template commands 402 connected via command links 404 can correspond to an evacuation command and follow-up/related commands that comprise a relationship to the evacuation command.

In another example, a command to construct a firebreak can be related to commands that achieve communication with other responder team(s), such as teams that comprise the raw materials to construct the firebreak, commands to evacuate area(s) proximate to the firebreak, timing parameters for when equipment and/or resources are to arrive to support the firebreak, a completion time for the firebreak, etc. Subsets of template commands 402 and the command links 404 that connect these subsets can comprise any suitable causal, temporal, or any other suitable relationships.

In some implementations, template commands 402 can comprise context information 406. A given one of context information 406 can be predefined situation-specific information for the ongoing situation that corresponds to its given instance of template commands 402, such as data that is the same as or similar to situational data and/or state information. In some implementations, a template commands' context information 406 can comprise tag(s) indicative of the template command's relevance. For example, a command to build a firebreak can include context such as: wind condition parameters (e.g., wind speeds/direction that may cause a first to spread), weather condition parameters (e.g., rain, heat, humidity, etc.), fire's proximity to residential areas or infrastructure, and the like. A recommendation model can select the one or more of template commands 402 for building a firebreak when the input fed to the recommendation model related to an ongoing situation (e.g., situational data and/or state information) matches context information 406 for the one or more template commands.

In some implementations, the recommendation model can rewrite, augment, or otherwise modify a selected template command to generate the recommended command(s). For example, a template command can be structured with command language (e.g., “build a fire break”) and relevant entities (e.g., “between the fire and a sensitive area at risk”, “using resources such as . . . ”). The learning model can edit and/or augment the command based on the situational data/state information fed to the model to generate a command relevant to the ongoing situation, such as “build a firebreak between the fire and ‘Residential Area X’ using ‘Resources Y and Z. In some implementations, the recommendation model is a generative language model that uses template command(s) as a reference and generates recommended commands specific to the ongoing situation by using the situational data and state information fed to the recommendation model. The recommendation model can rewrite, augment, edit, or otherwise use the selected template commands to generate a command recommendation (using situational data and/or state information fed to the model) via any suitable techniques implemented by generative language models.

In some implementations, a recommendation model can select one or more template commands 402 based on situational data/state information fed to the model matching context information 406 for the one or more template commands, and the recommendation model can also select one or more of the template commands 402 connected to the matching command via command links 404. For example, the recommendation model can: a) compare situational data and/or state information fed to the model to the context information for template commands 402, b) select one or more of the template commands 402 that match the data fed to the model; and c) generate the recommended command based on the selected template command and the situational data/state information fed to the model. The recommendation model (or any other suitable software) can then traverse the template command graph and select one or more additional template commands 402 connected to the originally selected template command by command links 404, and generate recommendations based on the additional selected template commands.

In some implementations, rather than a graph, plan data can comprise any other suitable structure. FIG. 4B is a conceptual diagram that illustrates plan data comprising template commands according to example embodiment(s). Diagram 400B illustrates template plan 410, situation identifier 412, and template commands 414. Similar to FIG. 4A, template commands 414 can comprise context that is used by a recommendation model to match/select the template commands. Different types of ongoing situations can correspond to different template plans. Situation identifier 412 can indicate the ongoing situation(s) that correspond to template plan 410 (e.g., forest fire, brush fire, residential fire, etc.). In template plan 410, template commands 414 can be organized as a list, vector, or any other suitable structure of template commands.

The situational data ingested via the command and control stack can be multi-modal data, such as image-based data, natural language data (e.g., phone, radio, speech detected by a microphone, etc.), sensor data, data from public or proprietary databases, live or static data, and the like. For example, the command and control stack can ingest real-time, multi-modal, and multimedia sensor data from a variety of space, air, ground, surface, and fixed sources, such as via universal resource locator (URL) streaming addresses and/or application programming interfaces (APIs) that can be used to obtain the data.

In some implementations, sensor data can be directed into layered processing according to media type. One or more software components, such as analytical model(s), artificial intelligence, and/or machine learning models, can process the data and generate processed output. For example, a multi-modal communication (MMC) component can be a speech-to-text transcriber which has been specifically trained for responder lingo using Event-Sensor-Action (ESA) dataset(s). For example, training the speech-to-text transcriber using the ESA dataset for public safety language/lingo improves transcription accuracy to better than 80%. Without specialized training, a commercial transcriber accuracy can be as low as the 20%-30% range. Additionally, the command and control stack transcription technology can recognize key words to trigger alerts and recommendations based on similar prior events. The MMC component can also ingest radio channel(s) via commercial Radio over IP (RoIP) products and provide improved comprehension through a channel spatial separation capability.

With respect to ingesting image(s) and/or video, embodiments of the command and control stack can use any suitable commercial computer vision video processing software, such as AWS Rekognition trained via the ESA dataset(s), AWS Sage Maker, and the like. This training can provide the functionality to recognize violent or undesirable traits, such as suspected shooters, drug deals, bullying, sexual harassment, gang violence, hate crimes, rioting, among others. Embodiments of the command and control stack can also use components of MindHive for ingesting image(s) and/or video. MindHive can provide geo and time tagged video fusion so that multiple video angles, views, perspectives of a given incident at a given time, at a given location—can be fused together providing a better glance at the incident situation. In some examples, audio from the video can be similarly processed and co-managed to allow for further model learning, model inference, and/or model validation.

The output from the layered processing (e.g., annotated streams, with alerts, triggers, object detection, keyword detection, etc.) can then be provided to an ensemble learning model, such as a model trained by data from prior incidents/events. The ensemble learning model can provide suggested commands (e.g., response actions) to a responder team and/or commander.

In some embodiments, each layer outputs processed media that is geo-tagged and time-tagged into the ensemble learning model. The model can be fed a variety of relevant situational data, such as weather data, traffic data, crime data, and other real-time data that will impact a responder team. The ensemble learning model can also be fine-tuned for each responder team using an action-actor model derived from each responders' preferences—meaning the learning model can be personalized. Command recommendations can be personalized for a responder team and/or commander using personalized plan data (e.g., template commands, historical commands, etc.) and/or model fine-tuning (e.g., additional training of a prior trained model) using historical situational data from the responder team and/or commander.

The ensemble learning model can provide conflicting data resolution and suggested commands (e.g., response actions) from a combination of approved action plans and prior incidents used to train/configure the recommendation model. The responder team may implement or ignore the command recommendations. The ensemble learning model can learn from the commander's decisions as well as the responder team's actions/outcomes. For example, action reports can be autogenerated and used augment the learning model as well as inform responder stakeholders.

In some implementations, components of the command and control stack are hosted at AWS cloud, such as AWS Government. Command and control stack can also include AWS Forecast and Personalization driven by a learning model trained with ESA training datasets. For example, AWS forecast can organize multi-layer situational data (e.g., processed voice, video, and other data) and generate recommendations and reasoning to aid with command decisions. When a recommendation command is adopted by a responder team and/or command, the command and control stack can then further recommend commands for scheduling, allocation/assignment, and task management, such as via the multi-modal, multi-media, and real-time situational data ingested. Command and control stack functionality related to transcribing dialogues (e.g., among response members), implementing a digital agent, and/or text comprehension can include components of AWS Comprehend, AWS Poly and AWS Lex.

FIG. 5 illustrates a flow diagram for training a machine learning model to generate situation-specific command recommendations according to example embodiment(s). Process 500 can be performed before, during, and/or after an ongoing situation. Process 500 can be performed via cloud system(s), edge system(s), personal computing system(s) (e.g., laptop, desktop, smart home device, etc.), wearable device(s) (e.g., smartwatch, smart glasses, etc.), mobile device(s) (e.g., smartphone, tablet, etc.) any combination thereof, or any other suitable computing device(s).

At block 502, process 500 can process training data. For example, historical situational data can be processed to generate training data for an ensemble machine learning model. First training data for a first model of the ensemble machine learning model can train the first model to recognize state information from input comprising situational data of an ongoing situation. Second training data for a second model of the ensemble machine learning model can train the second model to generate recommended commands for an ongoing situation.

Historical situations can be, for example, a fire (e.g., forest/brush fire, fire in a residential area, fire in a commercial area, house fire, apartment fire, fire in a commercial building, fire in a school, etc.), violence against a group of people, structure(s), or any other suitable violence or attack (e.g., international or domestic terrorist attack, mass shooting, riots, etc.), weather related emergency (e.g., hurricane, flooding, etc.), global relief issue (e.g., humanitarian aid distribution, etc.), public safety issue, a military operation, any other suitable situation that impacts a group of people and/or a large area, or any other suitable ongoing situation. During these historical ongoing situations, responder teams may perform actions, issue commands, and respond to the situations.

Historical situational data can be generated, stored, and aggregated related to the historical situations and responder team actions during the historical situations. Historical situational data for historical situations can include images or video (e.g., video of people, places, buildings, threats, and the like) via unmanned aerial vehicles, manned aircraft, body and/or dash cameras, fixed cameras, social media feeds, or any other suitable sources of images or video, audio (e.g., dialogue between responders or impacted individuals, audio from the scene(s) of the ongoing situation, etc.) via smartphones, landline calls, communication device(s) among responder team members, fixed microphone(s), or any other suitable source for audio, sensor data (e.g., fire or smoke detectors, air quality sensors, gunshot or panic detectors, traffic sensors, flood sensors, temperature sensors, etc.), data from other suitable sources (e.g., traffic conditions, weather conditions, tides/currents, sewage and/or plumbing information, flood zones, indoor and/or outdoor imagery or blueprints, building schematics, street maps, geographic information system (GIS) data, etc.), intelligence information (e.g., discovered, known, and/or suspected information about an ongoing threat), or any other suitable situational data.

For a given type of historical situation (e.g., fire, riot, active shooter, etc.), training data can be generated from the historical situational data generated. For example, one or more machine learning models can be trained/configured to compile training data from historical situational data generated during the given type of historical situation. The machine learning model(s) can comprise a natural language processing model trained to recognize states for the historical situations from communication (e.g. transcripts) among people related to the historical situation (e.g., responder team members, bystanders, other radio data, etc.) logs of communication applications used to issue commands, and the like. Example recognized states can include a fire's size, location, and/or intensity, the evacuation state of a building (e.g., populated or evacuated), the presence of hostages during a criminal situation, a violent individual(s) whereabouts during a criminal situation, or any other suitable state information. Once a state of a historical situation is recognized, the recognized state (e.g., training label) and the historical situational data relevant to that recognized state (e.g., proximate in time to when the historical situation comprises the state) can be compiled into a training instance for first training data.

In another example, a person can manually label historical situational data with recognized state(s) to generate training instance(s) for the first training data. In some implementations, after action report(s) compiled for a historical situation can indicate state information at different points of time during the historical situation. The state information indicated by the after action report(s) and a timing for this state information can be correlated to historical situational data generated during/for the historical situation. For example, the state information from the after action report(s) and the correlated historical situational data can be compiled into training instances for the first training data.

In another example, the machine learning model(s) can comprise a natural language processing model trained to identify issued commands from communication (e.g. transcripts) among responder team members, logs of communication applications used to issue commands, and the like. Issued commands can take the form of actions directed to responders, actions performed during the historical situations, or any other suitable actions for responding to the historical situations. The natural language processing model can be trained/configured to identify language that resembles the form of issued commands. Once a command issued during a historical situation is identified, the issued command (e.g., training label) and the historical situational data relevant to that issued command (e.g., proximate in time to when the command is issued) can be compiled into a training instance for second training data.

In another example, a person can manually label historical situational data with command(s) to generate training instance(s) for the second training data. In some implementations, after action report(s) compiled for a historical situation can indicate issued commands at different points of time during the historical situation. The issued commands indicated by the after action report(s) and a timing for these issued commands can be correlated to historical situational data generated during/for the historical situation. For example, the issued commands from the after action report(s) and the correlated historical situational data can be compiled into training instances for the second training data.

At block 504, process 500 can train machine learning model(s). For example, an ensemble machine learning model can be trained by the processed training data. In some implementations, the first training data can train the first model of the ensemble machine learning model and the second training data can train the second model of the ensemble machine learning model. The fist training data and second training data can comprise distinct training sets or portions of these training sets can overlap.

The first training data can train the first model to detect state information from situational data for an ongoing situation. The second training data can train the second model to understand situational data in a manner that supports generating command recommendations (e.g., based on plan data). The first model and/or the second model can comprise an LLM, and the training can include training the LLM. In some implementations, training the LLM can include finetuning a pretrained LLM, such as via training a limited set of the LLM's parameters. Training the LLM(s) can comprise propagating gradients to the parameters being trained via gradient descent. Any suitable optimization techniques can be used to improve the computational efficiency of finetuning the LLM(s). The LLM(s) can be trained in any other suitable manner. The first model and/or the second model can comprise any other suitable neural network or machine learning model with trainable parameters.

In some implementations, the processed training data is designed to train an ensemble learning model with respect to a specific type of situation. For additional situation types, additional sets of training data can be processed and used to train additional ensemble learning models.

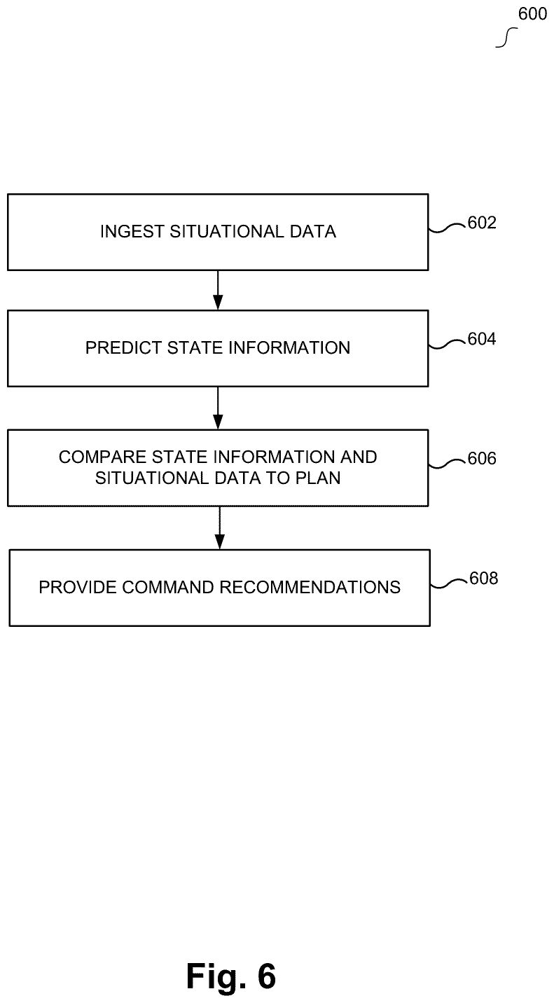

At block 506, process 500 can deploy the trained machine learning model(s). For example, the ensemble machine learning model can be deployed to generate command recommendations during an ongoing situation. Process 600 of FIG. 6 further describes generating command recommendations for an ongoing situation using the trained ensemble machine learning model.

At block 508 process 500 can update the trained machine learning model(s). For example, as ongoing situations occur and/or are resolved, additional training instances can be compiled from the situational data observed during the ongoing situations. The training of the first and/or second model of the ensemble model can be updated using these additional training instances.

In some implementations, the historical situations and historical situational data processed to generate the second training data for the second model of the ensemble model can be tailored to a responder team and/or commander. A responder team and/or commander may have responded to a limited set of historical situations, and the historical situational data from this limited set of situations can be used to generate training instances for the second training data. In some implementations, the training instances for the second training data can be augmented by using historical situational data from historical situations outside this limited set, for example until the second training data meets a size criteria (e.g., comprises a threshold number of training instances that will effectively train/update the second model). In this example, over time the training of the ensemble model can be personalized to a given responder team and/or commander.

FIG. 6 illustrates a flow diagram for generating situation-specific command recommendations using machine learning according to example embodiment(s). Process 600 can be performed before, during, and/or after an ongoing situation. Process 600 can be performed via cloud system(s), edge system(s), personal computing system(s) (e.g., laptop, desktop, smart home device, etc.), wearable device(s) (e.g., smartwatch, smart glasses, etc.), mobile device(s) (e.g., smartphone, tablet, etc.) any combination thereof, or any other suitable computing device(s).

At block 602, process 600 can ingest situational data. For example, situational data can be ingested from multiple data sources. The situational data can include image-based situational data and natural language data that relates to an ongoing situation. At least a portion of the situational data can relate to response activities of a responder team for the ongoing situation, such as transcribed dialogue via responder team members (e.g., radio, phone conversations, messages, etc.). In some implementations, ingested image-based situational data can be descriptions of images or video data related to the ongoing situation, and ingested natural language data can be transcripts of conversations among individuals related to the ongoing situation.

The ongoing situation can be, for example, a fire (e.g., forest/brush fire, fire in a residential area, fire in a commercial area, house fire, apartment fire, fire in a commercial building, fire in a school, etc.), violence against a group of people, structure(s), or any other suitable violence or attack (e.g., international or domestic terrorist attack, mass shooting, riots, etc.), weather related emergency (e.g., hurricane, flooding, etc.), global relief issue (e.g., humanitarian aid distribution, etc.), public safety issue, a military operation, any other suitable situation that impacts a group of people and/or a large area, or any other suitable ongoing situation. Input source(s) can be any source for situational data related to the ongoing situation, such as images or video (e.g., video of people, places, buildings, threats, and the like) via unmanned aerial vehicles, manned aircraft, body and/or dash cameras, fixed cameras, social media feeds, or any other suitable sources of images or video, audio (e.g., dialogue between responders or impacted individuals, audio from the scene(s) of the ongoing situation, etc.) via smartphones, landline calls, communication device(s) among responder team members, fixed microphone(s), or any other suitable source for audio, sensor data sources (e.g., fire or smoke detectors, air quality sensors, gunshot or panic detectors, traffic sensors, flood sensors, temperature sensors, etc.), other suitable data sources (e.g., traffic conditions, weather conditions, tides/currents, sewage and/or plumbing information, flood zones, indoor and/or outdoor imagery or blueprints, building schematics, street maps, geographic information system (GIS) data, etc.), intelligence information sources (e.g., discovered, known, and/or suspected information about an ongoing threat), or any other suitable situational data sources.

At block 604, process 600 can recognize state information for the ongoing situation. For example, a first model of an ensemble machine learning model can recognize state information from the situational data. The first model can comprise a neural network, generative natural language model (e.g., LLM, etc.), or any other suitable machine learning model(s). The recognized state information can represent a model-based understanding of the ongoing situation based on how the ongoing situation is represented by the situational data.

At block 606, process 600 can generate recommended commands. For example, a second model of the ensemble machine learning model can generate the recommended commands using the recognized state information and at least a portion of the situational data. The second model can be a generative natural language model (e.g., large language model) configured to compare a) at least a portion of the situational data and the recognized state information; and b) a plan data for the ongoing situation that comprises template commands. In some implementations, the second model can select, based on the comparison, one or more template commands that match the portion of the situational data and the recognized state information, and the second model can generate the recommended commands using the matching one or more template commands. For example, the second model can generate at least a portion of the recommended commands by editing, augmenting, or rewriting the matching one or more template commands using the portion of the situational data and the recognized state information.

In some implementations, the plan data can include the template commands and descriptive information that describes a context for the template commands, and the second model can generate the recommended commands by selecting one or more of the template commands that match the situational data and state information. For example, the plan data can include a graph of template commands and links among the template commands, the graph can store context for each template command, and the second model can generate the recommended commands by a) comparing the situational data and state information to the graph and b) selecting matching template commands. In some implementations, the context for a given template command can be tags of: predefined situational data associated with the given template command; predefined state information associated with the given template command, or any combination thereof.

In some implementations, the plan data can include historical commands and context for these historical commands. For example, the second model can generate the recommended commands by selecting one or more of the historical commands that match the situational data and state information. The second model can generate at least a portion of the recommended commands by editing, augmenting, or rewriting the matching one or more historical commands using the portion of the situational data and the recognized state information.

At block 608, process 600 can provide command recommendation(s) to a member for a responder team. For example, the command recommendation(s) can be provided to the responder team member via a dashboard, digital agent (e.g., as output text and/or output audio), or in any other suitable manner. In some implementations, the recommended commands can be generated via the second model with a confidence value. The command recommendations provided to the member of the responder team can comprise a confidence value that meets a criteria (e.g., exceeds a threshold).

In some implementations, recommended commands can be tailored to specific members of the responder team. For example, the responder team can include a logistics commander, a pilot, on-the-ground responders, and the like. Embodiments can tailor the generated recommendations to the role of the responder team member. For example, an identifier for the role of the responder team member can be provided to the ensemble learning model, and the model can be trained to associate the role with certain commands/actions (e.g., based on the identifier being part of the model's training data). In another example, portions of the plan data (e.g., template commands and/or historical commands) can include role information as part of the predefined context for the template/historical commands, and thus the model can select template/historical commands that correspond to the role identifier when generating command recommendations.

In some implementations, the ongoing situation can continue such that additional situational data is ingested that represents new developments for the ongoing situation. Blocks 602-608 can be iterated over to continue to generate command recommendations during the ongoing situation based on additional situational data.

In some implementations, a feedback manager can compile training instances of: state information recognized by the first model that is inaccurate; and/or recommended commands generated by the second model that are not performed by the responder team. For example, the feedback manager can process the additional situational data to compile the training instances. The training of the first model and/or second model can then be updated using at least the compiled training instances.

Implementations generate situation-specific command recommendations using machine learning. A response to a multi-faceted situation can be challenging to devise and coordinate. For example, a responder team (e.g., commander, responders, etc.) may perform actions to manage the situation while it is ongoing, and to be effective those actions should be strategic, precise, and coordinated. Implementations of a command and control stack can ingest situational data for the ongoing situation and generate command recommendations for the responder team. For example, an ensemble machine learning model that comprises multiple model components can be trained to generate command recommendations using the ingested situational data. The command recommendations can be provided to member(s) of the responder team, such as displayed via a dashboard, provided via a digital agent, and the like.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure.

We claim:

1. A method for resolving commands for responding to an ongoing situation using machine learning, the method comprising:
ingesting situational data from multiple data sources,
wherein the situational data comprises image-based situational data and natural language data that relates to an ongoing situation, and
wherein at least a portion of the situational data relates to response activities of a responder team for the ongoing situation;
generating, by an ensemble machine learning model comprising at least first model and a second model, recommended commands by:
recognizing, via the first model using the ingested situational data, state information about the ongoing situation;
generating, via the second model, the recommended commands, wherein,
the second model comprises a generative natural language model configured to compare a) at least a portion of the situational data and the recognized state information; and b) plan data for the ongoing situation that comprises template commands, and
the second model generates the recommended commands based on the comparison; and
providing the recommended commands to a member of the responder team.

2. The method of claim 1, wherein the second model selects, based on the comparison, one or more template commands that match the portion of the situational data and the recognized state information, and the second model generates the recommended commands using the matching one or more template commands.

3. The method of claim 2, wherein the second model generates at least a portion of the recommended commands by editing, augmenting, or rewriting the matching one or more template commands using the portion of the situational data and the recognized state information.

4. The method of claim 1, wherein the plan data comprises the template commands and descriptive information that describes a context for the template commands, and the second model generates the recommended commands by selecting one or more of the template commands that match the portion of the situational data and state information.

5. The method of claim 1, wherein the plan data comprises a graph of template commands and links among the template commands, the graph stores context for each template command, and the second model generates the recommended commands by a) comparing the portion of the situational data and state information to the graph and b) selecting matching template commands.

6. The method of claim 5, wherein the context for a given template command comprises tags of: predefined situational data associated with the given template command; predefined state information associated with the given template command, or any combination thereof.

7. The method of claim 1, wherein the ongoing situation comprise a wildfire, one or more violent individuals, a riot, a weather event, a global relief effort, a military or police event, or any combination thereof.

8. The method of claim 1, wherein additional situational data is ingested from the multiple data sources at a point in time after the situational data is ingested, and wherein the method further comprises:
compiling, by a feedback manager, training instances of: state information recognized by the first model that is inaccurate; and/or recommended commands generated by the second model that are not performed by the responder team, wherein the feedback manager processes the additional situational data to compile the training instances; and
updating a training of the first model and/or the second model using at least the training instances.

9. The method of claim 1, wherein the ingested image-based situational data comprises descriptions of images or video data related to the ongoing situation, and the ingested natural language data comprises transcripts of conversations among individuals related to the ongoing situation.

10. A non-transitory computer-readable storage medium for resolving commands for responding to an ongoing situation using machine learning, the computer-readable storage medium storing instructions that, when executed by a computing system, cause a computing system to:
ingest situational data from multiple data sources,
wherein the situational data comprises image-based situational data and natural language data that relates to an ongoing situation, and
wherein at least a portion of the situational data relates to response activities of a responder team for the ongoing situation;
generate, by an ensemble machine learning model comprising at least first model and a second model, recommended commands by:
recognizing, via the first model using the ingested situational data, state information about the ongoing situation;
generating, via the second model, the recommended commands, wherein,
the second model comprises a generative natural language model configured to compare a) at least a portion of the situational data and the recognized state information; and b) plan data for the ongoing situation that comprises template commands, and
the second model generates the recommended commands based on the comparison; and
providing the recommended commands to a member of the responder team.

11. The non-transitory computer-readable storage medium of claim 10, wherein the second model selects, based on the comparison, one or more template commands that match the portion of the situational data and the recognized state information, and the second model generates the recommended commands using the matching one or more template commands.

12. The non-transitory computer-readable storage medium of claim 11, wherein the second model generates at least a portion of the recommended commands by editing, augmenting, or rewriting the matching one or more template commands using the portion of the situational data and the recognized state information.

13. The non-transitory computer-readable storage medium of claim 10, wherein the plan data comprises the template commands and descriptive information that describes a context for the template commands, and the second model generates the recommended commands by selecting one or more of the template commands that match the portion of the situational data and state information.

14. The non-transitory computer-readable storage medium of claim 10, wherein the plan data comprises a graph of template commands and links among the template commands, the graph stores context for each template command, and the second model generates the recommended commands by a) comparing the portion of the situational data and state information to the graph and b) selecting matching template commands.

15. The non-transitory computer-readable storage medium of claim 14, wherein the context for a given template command comprises tags of: predefined situational data associated with the given template command; predefined state information associated with the given template command, or any combination thereof.

16. The non-transitory computer-readable storage medium of claim 10, wherein the ongoing situation comprise a wildfire, one or more violent individuals, a riot, a weather event, a global relief effort, a military or police event, or any combination thereof.

17. The non-transitory computer-readable storage medium of claim 10, wherein additional situational data is ingested from the multiple data sources at a point in time after the situational data is ingested, and wherein the instructions, when executed by the computing system, further cause the computing system to:
compile, by a feedback manager, training instances of: state information recognized by the first model that is inaccurate; and/or recommended commands generated by the second model that are not performed by the responder team, wherein the feedback manager processes the additional situational data to compile the training instances; and
update a training of the first model and/or the second model using at least the training instances.

18. The non-transitory computer-readable storage medium of claim 10, wherein the ingested image-based situational data comprises descriptions of images or video data related to the ongoing situation, and the ingested natural language data comprises transcripts of conversations among individuals related to the ongoing situation.

19. A computing system for resolving commands for responding to an ongoing situation using machine learning, the computing system comprising:
one or more processors; and
one or more memories storing instructions that, when executed by the one or more processors, cause the computing system to:
ingest situational data from multiple data sources,
wherein the situational data comprises image-based situational data and natural language data that relates to an ongoing situation, and
wherein at least a portion of the situational data relates to response activities of a responder team for the ongoing situation;
generate, by an ensemble machine learning model comprising at least first model and a second model, recommended commands by:
recognizing, via the first model using the ingested situational data, state information about the ongoing situation;
generating, via the second model, the recommended commands, wherein,
the second model comprises a generative natural language model configured to compare a) at least a portion of the situational data and the recognized state information; and b) plan data for the ongoing situation that comprises template commands, and
the second model generates the recommended commands based on the comparison; and
providing the recommended commands to a member of the responder team.

20. The system of claim 10, wherein the second model selects, based on the comparison, one or more template commands that match the portion of the situational data and the recognized state information, and the second model generates the recommended commands using the matching one or more template commands.
